(19) United States
(12) Patent Application Publication
(10) Pub. No.: US 2008/0206430 A1
(43) Pub. Date: Aug. 28, 2008

(54) COMPOSITIONS CONSISTING OF BLENDED VEGETARIAN PROTEINS

(76) Inventor: Rafael Avila, Farmingdale, NY (US)

Correspondence Address: ABELMAN, FRAYNE & SCHWAB, 666 THIRD AVENUE, 10TH FLOOR, NEW YORK, NY, 10017, US

(21) Appl. No.: 12/035,691

(22) Filed: Feb. 22, 2008

Related U.S. Application Data
(60) Provisional application No. 60/918,280, filed on Feb. 22, 2007.

(51) Int. Cl. A23L 1/305; A23L 2/66

(52) U.S. Cl. 426/590; 426/648

(57) ABSTRACT

A vegetarian nutritional supplement including soy protein, rice protein and pea protein which are blended in particular ratios, by weight, to impart a level of digestibility comparable to whey, which is the benchmark for non-vegetarian food products and nutritional supplements.

### FIELD OF THE INVENTION

The present invention relates to the provision of a food product which includes a blend of proteins and, more particularly, to a proteinaceous, vegetarian, food product or nutritional supplement with a high level of digestibility.

### BACKGROUND OF THE INVENTION

Over the past 25 years, the health food industry has seen a dramatic rise in the popularity of protein shakes. Protein shakes are consumed for a variety of purposes, ranging from assisting in weight loss to supporting muscle growth to enhancing general athletic performance. The variety of protein shake flavors on the market has also grown dramatically. Nowadays, with myriad delicious shakes available, some consumers purchase protein shakes with no specific purpose in mind, other than to enjoy the flavor or texture of a delicious shake.

Nevertheless, a majority of protein shake consumers do have a particular purpose in mind. One category of protein shakes, in which a particular purpose is a major purchasing consideration, is the soy protein meal replacement shake. When composed of strictly vegetable matter, such shakes appeal to vegetarians and non-vegetarians alike. For vegetarians specifically, soy protein meal replacement shakes are often used as a form of nutritional insurance, ensuring that the consumer is obtaining all of the essential amino acids. This owes to the fact that soy protein is known to be a complete protein, supplying all of the essential amino acids, with a digestibility nearly identical to that of whey protein.

Non-vegetarians have also been turning to soy protein based meal replacement shakes as a significant source of dietary protein for many reasons. One reason is the findings that 6.25 grams of soy protein per day, as part of a diet low in saturated fat and cholesterol, may reduce the risk of heart disease. Another is the fact that soy protein is generally low in fat and devoid of saturated fat. Thus soy protein can be used to help maintain or improve cardiovascular health, lose weight or simply obtain sufficient essential amino acids from the diet.

But recently, nutrition experts, including those from the USDA, US Food and Nutrition Board, Harvard School of Public Health, Boston College, University of Louisville, University of Wisconsin, as well as many others have been recommending that people obtain their daily requirements of protein from a variety of dietary sources.

Nutrition experts have established that the quality of dietary proteins is equally as important as, if not more important than, the quantity of protein present in the diet. A common method of evaluating the quality of protein since 1919 has been the Protein Efficiency Ratio. It is only later when the amino acid needs of humans were understood that the PER's shortcomings were recognized. In this method the use of rat requirements instead of human requirements resulted in overestimation of the quality of animal protein and underestimation of the quality of plant proteins. Growing rats have much higher needs than humans for the sulfur containing amino acid methionine to support growth. As a result, plant proteins were mistakenly recognized as being poor in quality, since the sulfur containing amino acids are often diminished in plant proteins. Thus, soy protein was considered to be inferior to animal protein.

Later, the protein quality was assessed by the Amino Acid score, Protein Digestibility Index (PDI), Nitrogen Solubility Index (NSI) and other parameters. While the Protein Digestibility Index requires the sample to be stirred with water in a high-speed blender for ten (10) minutes, the Nitrogen Solubility Index requires the sample to be stirred at a low speed for 2 hours. The difference in the values is quite significant, the NSI being generally somewhat lower than the PDI. In the interest of uniformity, the Joint Expert Consultation of FAO and WHO—1989 recommended a standard entitled Protein Digestibility-Corrected Amino Acid Score (PDCAAS) for evaluating protein quality, which was a more accurate method. PDCAAS is determined by the Amino Acid Content (mg/g protein) in Food Protein×Digestibility divided by Amino Acid Content.

The PDCAAS takes several factors into account including a food protein's indispensable amino acid content and its true digestibility. In order to meet even the most stringent protein requirements, the PDCAAS compares the amino acid content of food protein to the needs of a 2 to 5 year old child. The PDCAAS of the different sources of protein as shown in Table 1 reaffirms that well processed soy protein products can replace meat and fish proteins without affecting the overall utilization of dietary nitrogen.

TABLE 1
Selected PDCAAS Values

| Protein source | PDCAAS |
|---|---|
| Soy Protein | 1 |
| Casein and Whey | 1 |
| Egg white | 1 |
| Beef Protein | 0.92 |
| Pea Protein | 0.69 |
| Peanut meal | 0.52 |
| Rice | 0.47 |
| Corn | 0.42 |
| Whole Wheat | 0.4 |
| Wheat Gluten | 0.25 |

The objective of diversifying one's protein source in accordance with the recommendations of modern nutrition experts may be relatively simple at the consumer level. However, from a manufacturing and marketing standpoint, one must consider the relative digestibility of finished products containing protein from a variety of sources, as well as the flavor, texture and overall appeal. When marketing to a health-conscious consumer base, the question of digestibility is of critical importance, since those consumers are more likely to take into account the quality of the protein when selecting a protein shake. In developing products using diverse protein sources, a manufacturer must consider not only the ultimate digestibility of the final product, but also such factors as availability of raw materials, allergenicity of the protein sources and consumer perception of such sources.

### Prior Art

U.S. Pat. Nos. 6,294,206 and 6,472,003 to Barrett-Reis, et al. disclose an infant formula and a fortifier thereof, which may contain mixtures of various proteins among many ingredients. It does not, however, disclose any specific formulation of blended proteins, nor specific ratios or percentages of particular protein combinations to achieve a desired digestibility, namely, a level of digestibility that is comparable or similar to whey. Furthermore, it does not disclose any specific targets of digestibility or choices or combinations of any of the proteins referenced therein, so as to achieve a level of digestibility similar to whey, which represents the “gold standard” for non-vegetarians.

It is an object of the invention to provide a vegetarian nutritional supplement, for example, a shake, which is proteinaceous and which has a level of digestibility comparable to whey, which is non-vegetarian.

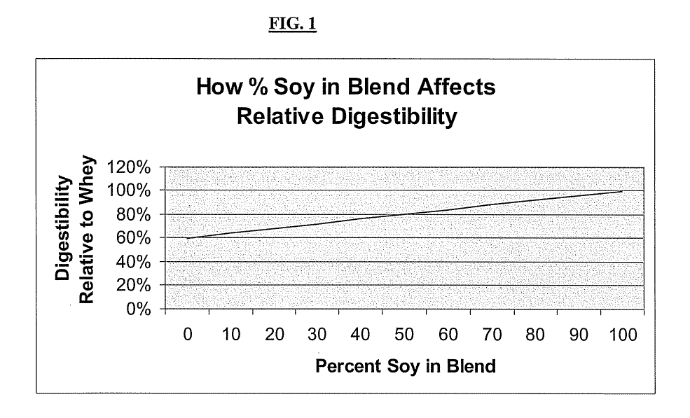

FIG. 1 is a graph that demonstrates how the percentage of soy protein in a vegetarian blend affects relative digestibility and protein quality.

### SUMMARY OF THE INVENTION

The instant invention is a nutritional supplement or food composition comprised of protein from soy, protein from rice and protein from peas, with the soy protein portion derived from fermented and/or non-fermented soy sources. This invention includes in an embodiment thereof, these proteins at certain percentages, which serve to impart a high level of digestibility to the supplement similar to that of whey. The composition is primarily designed for inclusion in vegetarian shakes, but may also be used in bars, drink mixes, tablets, wafers, liquids, ready-to-drink, spray nutritionals, soft-gels, chewable tablets, or any known form of ingestible food or supplement material.

### DETAILED DESCRIPTION OF THE INVENTION

Because of their good consumer perception, relatively high digestibilities, widespread availability and low allergenicities, both rice protein and pea protein make excellent choices as additional sources of protein to combine with soy.

In blending the three proteins of the present invention, the scope of the invention contemplates that the soy protein can be from about 20% to 95% by weight of the total protein content, and the rice and pea proteins can comprise between about 5% to 80%, by weight of the total protein.

It is preferred to combine 33⅓% by weight soy protein with a blend of 33⅓% rice protein and 33⅓% pea protein to achieve a blend with a relative digestibility that is similar to that of whey protein.

Table 2 demonstrates the relative digestibility of a protein blend that is 30% soy protein, with the remainder being 35% by weight, rice protein and 35% by weight, pea protein. The resulting digestibility is 0.72 on the PDCAAS scale, as compared with soy and whey, which both have PCDAAS values of 1.

### Relative Digestibility of a Soy:Rice:Pea 30:35:35 Protein Blend

TABLE 2

| | | | Relative |
|---|---|---|---|
| Protein source | PDCAAS | % Of Blend | Digestibility |
| Soy Protein | 1 | 30% | 0.3 |
| Pea Protein | 0.69 | 35% | 0.2415 |
| Rice | 0.47 | 35% | 0.1645 |
| | | | 0.72 |

If one plots the graph of percentages of soy protein in such a blend, increasing from zero to 100 (see FIG. 1.), it is apparent that a blend of soy protein with pea protein and rice protein achieves a relative digestibility that is less than 2.5 standard deviations away from that of whole soy protein or whey protein (assuming a normal distribution curve).

As FIG. 1 demonstrates, when the soy protein content of the protein blend reaches 20%, the relative digestibility and quality of the blend is about 60% that of soy or whey protein. When soy protein reaches 25% of the blend, the blend reaches 70% that of whey protein. Statistically speaking, this is where the blend becomes mathematically similar to soy protein alone or whey protein alone, in terms of digestibility and quality. A blend comprising 20% soy protein, regardless of the distribution of rice and pea protein in the remaining 80% of total protein would be the lower range of the invention's effectiveness as a replacement for 100% soy protein or 100% whey protein.

The technology of using such a blend in order to achieve a quality, and therefore digestibility of protein that is comparable to that of whey, as a primary component of dietary supplements and/or shakes and/or bars has not been previously disclosed or contemplated. This invention encompasses all levels of soy protein (fermented as well as non-fermented) whereby, when it is combined with pea protein and rice protein, the blend has a quality and/or digestibility similar to that of whey.

In addition to the relative digestibility and protein quality, the flavor, texture and overall appeal of the protein blend in finished products was considered. Several double-blinded taste tests were conducted in order to assess the value of the blend as compared to isolated soy protein.

The first test was designed to determine the consumer's ability to identify the soy-based product or the soy-rice-pea blend based product from unmarked samples. Ten subjects were given an unmarked sample of the original Chocolate Flavored SPIRU-TEIN Shake (100% soy protein based) and an equivalently sized sample of the same shake, except that the soy protein had been replaced with a blend of 33% soy protein, 33% rice protein and 33% pea protein. Neither the administrator nor the subjects knew the identity of the samples. All 10 subjects were familiar with and had previously consumed the original Chocolate SPIRU-TEIN Shake, which was made with 100% soy protein as the base. Despite their familiarity with the original product, only 3 of the 10 subjects correctly identified the soy or soy-rice-pea based shakes.

A second test was conducted using the original Vanilla SPIRU-TEIN Shake product, and the same formulation in which the soy protein had been replaced with a blend of equal parts soy, rice and pea proteins. This test yielded results similar to the first; 4 of the 10 subjects were able to correctly identify the form of protein base in the unmarked samples.

A third test was conducted in order to determine the overall appeal of products using the soy-rice-pea protein blend versus products using soy protein alone. Ten subjects were given an unmarked sample of the original Chocolate Flavored SPIRU-TEIN Shake (100% soy protein based) and an equivalently sized sample of the same shake, except that the soy protein had been replaced with a blend of 33% soy protein, 33% rice protein and 33% pea protein. Neither the administrator nor the subjects knew the identity of the samples. All 10 subjects were familiar with and had previously consumed the original Chocolate SPIRU-TEIN Shake. Subjects were asked which sample they preferred. Seven out of ten chose the soy-rice-pea protein blend-based product.

The first two tests confirm that consumers familiar with shakes that use 100% soy protein as their sole source of protein cannot identify the 100% soy product when given unmarked soy and soy-rice-pea based products. Assuming the flavors to be identical, the probability of correctly identifying the protein base is 50%. However, the subjects did not even achieve a 50% success rate in either the first or second test. The evidence shows that consumers familiar with products made with 100% soy protein, are unable to identify the 100% soy protein containing products, which suggests that a 100% soy-protein base imparts no uniquely defining taste, texture or other characteristic that consumers can identify, much less desire. These tests show that the soy-rice-pea blend is an excellent substitute for a 100% soy based shake.

Meanwhile, the third test shows that consumers appear to have a preference for the overall appeal of the soy-rice-pea blend over the 100% soy protein base. While consumers do not seem to be aware of any unique, desirable flavor or texture characteristic of the 100% soy base, their preference for the overall appeal of the soy-rice-pea blend is unmistakable, with 70% having chosen the blend.

Set forth below is an exemplary formulation which includes the soy-rice-pea protein blend of the present invention in the form of a shake.

Accordingly, it will be appreciated that the present invention has been described with reference to particular preferred embodiments that are now contemplated. However, the invention is not limited to the embodiments disclosed herein and it will be appreciated that numerous modifications and other embodiments may be devised by those skilled in the art. Therefore, it is intended that the appended claims cover all such modifications and embodiments that fall within the spirit and scope of the present invention.

What is claimed is:

1. A vegetarian nutritional supplement comprising a blend of soy protein, rice protein and pea protein.

2. The supplement of claim 1, wherein the soy protein is selected from the group consisting of fermented soy, non-fermented soy, and mixtures thereof.

3. The supplement of claim 1, wherein the soy protein is about 20% to about 95% by weight of the total protein content of the supplement, and the pea protein and rice protein combined are about 5% to 80% by weight, of the total protein content of the supplement.

4. The supplement of claim 3, wherein the soy, rice and pea proteins are each about 33⅓% by weight, of the total protein content.

5. The supplement of claim 1, wherein the soy protein is about 30%, by weight, of the total protein content and the pea protein and rice protein are each about 35%, by weight, of the total content.

6. The supplement of claim 5, wherein the relative digestibility of the supplement is about 0.72 or higher as measured by the Protein Digestibility-Corrected Amino Acid Score (PDCAAS).

7. The supplement of claim 1 in the form of a shake, bar, drink mix, tablet, wafer, liquid, ready-to-drink, spray nutritionals, soft gels or chewable tablet.
